(19) United States
(12) Patent Application Publication
(10) Pub. No.: US 2017/0067926 A1
(43) Pub. Date: Mar. 9, 2017

(54) LABORATORY ANALYZER FOR MANUALLY HANDLING A PLURALITY OF REAGENTS AND METHOD FOR OPERATING A LABORATORY ANALYZER FOR MANUALLY HANDLING A PLURALITY OF REAGENTS

(71) Applicant: Roche Diagnostics Operations, Inc., Indianapolis, IN (US)

(72) Inventor: Michael Meyberg, Zug (CH)

(21) Appl. No.: 15/254,105

(22) Filed: Sep. 1, 2016

(30) Foreign Application Priority Data
Sep. 8, 2015 (EP) 15184242.4

(51) Int. Cl. G01N 35/00; B01L 3/00

(52) U.S. Cl. CPC G01N 35/00722; B01L 3/527; G01N 2035/0091

(57) ABSTRACT

A laboratory analyzer for manually handling a plurality of reagents is disclosed. The laboratory analyzer comprises a computing device comprising a display for displaying a workflow of a pipetting process comprising a plurality of method steps to an operator, a pipette for pipetting reagents connected to the computing device, a plurality of compartments for receiving a plurality of reagents vessels including reagents to be pipetted by the pipette, and a camera connected to the computing device. The camera is adapted to acquire data from a vision analysis of at least the plurality of compartments during manually carrying out a pipetting process by the operator according to the workflow. The computing device is adapted to compare the data to target data correlated to the plurality of method steps of the workflow. Further, a method for operating a laboratory analyzer for manually handling a plurality of reagents is disclosed.

### CROSS-REFERENCE TO RELATED APPLICATIONS

This application claims priority to EP 15184242.4, filed Sep. 8, 2015, which is hereby incorporated by reference.

### BACKGROUND

The present disclosure generally relates to a laboratory analyzer and method for handling reagents and, in particular, to such a laboratory analyzer and method for handling reagents including a pipette and a computing device.

The pipette of the laboratory analyzer is connected to the computing device. A user of the laboratory analyzer is guided through a manual pipetting workflow by a display of the computing device. As the manual pipette is electronically connected to the computing device, the pipette can be controlled by the computing device. Thus, a basic control of some pipetting parameters is provided by the computing device such as volume selection, dispense and aspirate functions.

The computing device allows a control of the electronic pipette such as a data exchange with the electronic pipette, a display of workflow and functions, an automated generation of reports, and an electronic connection via USB or wireless connection. Further, the computing device allows a vision control for and display of measurement of dispensed volume, droplets, a position of pipette tip, microscope consumables identification and spatial localization, and tip and tip volume control.

However, there may be multiple places from which the user can aspirate reagents from and multiple other places where the reagent can be dispensed into different vessels. Moreover the reagent type may be coded by different colors and it has to be placed at a correct position prior to pipetting. The same is true for a cuvette, which, in addition to that, may have to be connected to the electronic of the computing device for measurement. Positions for cuvettes and reagents as well as the pipetting order can be mixed up by accident leading to false results of the analysis.

Therefore, there is a need for a laboratory analyzer for handling reagents and a method for operating a laboratory analyzer for handling reagents adapted to provide an improved user's guidance through the manual pipetting workflow without the risk of a deviation from the target pipetting workflow.

### SUMMARY

According to the present disclosure, a method and a laboratory analyzer for manually handling a plurality of reagents are presented. The laboratory analyzer can comprise a computing device comprising a display for displaying a workflow of a pipetting process comprising a plurality of method steps to an operator, a pipette for pipetting reagents connected to the computing device, a plurality of compartments for receiving a plurality of reagents vessels including reagents to be pipetted by the pipette, and a camera connected to the computing device. The camera can be adapted to acquire data from a vision analysis of at least the plurality of compartments during manually carrying out a pipetting process by the operator according to the workflow. The computing device can be adapted to compare the data to target data correlated to the plurality of method steps of the workflow.

Accordingly, it is a feature of the embodiments of the present disclosure to provide a laboratory analyzer for handling reagents and a method for operating a laboratory analyzer for handling reagents adapted to provide an improved user's guidance through the manual pipetting workflow without the risk of a deviation from the target pipetting workflow. Other features of the embodiments of the present disclosure will be apparent in light of the description of the disclosure embodied herein.

### BRIEF DESCRIPTION OF THE SEVERAL VIEWS OF THE DRAWING

The following detailed description of specific embodiments of the present disclosure can be best understood when read in conjunction with the following drawing, where like structure is indicated with like reference numerals and in which:

FIG. 1 illustrates a perspective view of a laboratory analyzer for manually handling a plurality of reagents according to an embodiment of the present disclosure.

### DETAILED DESCRIPTION

In the following detailed description of the embodiments, reference is made to the accompanying drawing that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

As used in the following, the terms “have”, “comprise” or “include” or any arbitrary grammatical variations thereof can be used in a non-exclusive way. Thus, these terms may both refer to a situation in which, besides the feature introduced by these terms, no further features are present in the entity described in this context and to a situation in which one or more further features may be present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it can be noted that the terms “at least one”, “one or more” or similar expressions indicating that a feature or element may be present once or more than once typically can be used only once when introducing the respective feature or element. In the following, in most cases, when referring to the respective feature or element, the expressions “at least one” or “one or more” may not be repeated, non-withstanding the fact that the respective feature or element may be present once or more than once.

Further, as used in the following, the terms “preferably”, “more preferably”, “particularly”, “more particularly”, “specifically”, “more specifically” or similar terms can be used in conjunction with optional features, without restricting alternative possibilities. Thus, features introduced by these terms can be optional features and may not be intended to restrict the scope of the claims in any way. The present disclosure may, as the skilled person can recognize, be performed by using alternative features. Similarly, features introduced by “in an embodiment” or similar expressions can be intended to be optional features, without any restriction regarding alternative embodiments, without any restrictions regarding the scope of the invention and without any restriction regarding the possibility of combining the features introduced in such way with other optional or non-optional features of the invention.

A laboratory analyzer for handling reagents is disclosed. A laboratory analyzer in the sense of the present disclosure can be a device adapted to analyze samples. The samples to be analyzed can be prepared for the analysis using at least one reagent. In one embodiment, the laboratory analyzer can be used for electrochemical and/or spectroscopic experiments.

The laboratory analyzer can comprise a computing device comprising a display for displaying a workflow of a pipetting process comprising a plurality of method steps to an operator. A workflow can be a predetermined pattern of instructions to be carried out by the operator of the laboratory analyzer. The workflow is illustrated as a sequence of operations or method steps in a graphical manner such as by pictures and/or by readable text. A pipetting process can be a process carried out using a pipette. The pipetting process can includes a transport a measured volume of a liquid.

As such, the laboratory analyzer can comprise a pipette for pipetting reagents connected to the computing device. A pipette can be a laboratory tool commonly used in chemistry, biology and medicine to transport a measured volume of liquid. Pipettes can come in several designs for various purposes with differing levels of accuracy and precision, from single piece glass pipettes to more complex adjustable or electronic pipettes. Many pipette types work by creating a partial vacuum above a liquid-holding chamber and selectively releasing this vacuum to draw up and dispense liquid. The pipette can be connected to the computing device for allowing an exchange of data correlated to the pipetting process. As such the pipette may be an electronic pipette controlled by the computing device. The connection of the pipette to the computing device may be realized by a cable such as an USB cable or by a wireless connection such as Bluetooth.

The laboratory analyzer can further comprise a plurality of compartments for receiving a plurality of reagents vessels including reagents to be pipetted by the pipette. A reagent vessel can be a vessel suitable to include or store a reagent. A reagent can be a substance or compound that can be added to a system or sample in order to bring about a chemical or biological reaction, or added to see if a reaction occurs.

The laboratory analyzer can further comprise a camera connected to the computing device. The camera can be adapted to acquire data from a vision analysis of at least the plurality of compartments during manually carrying out a pipetting process by the operator according to the workflow. A vision analysis can be an analysis method using a camera for optical detection of predetermined regions of the laboratory. The results of the detection can be represented by data. In other words, the camera can be used in order to observe predetermined regions of the laboratory analyzer. Manually carrying out the pipetting process can be understood that the operator manually can carry out at least one of the plurality of the method steps of the pipetting process. Thus, the workflow can include at least one method step which may not be carried out in an automated manner by the laboratory analyzer. For example, a manual step of the method steps can be the arrangement of the reagent vessels in the compartments by the operator, aspirating reagent into the pipette while the operator operates the pipette or dispensing the reagent from the pipette while the operator operates the pipette.

The computing device can be adapted to compare the data to target data correlated to the plurality of method steps of the workflow. In other words, the computing device can be adapted to compare actual data to target data associated with the method steps. For example, the data can include information of the position of the pipette and/or a reagent vessel and the target data can include information of a target position of the pipette and/or the reagent vessel at a predetermined one of the method steps. In other words, the computing device can detect whether the pipette and/or the reagent vessel is located at a correct position at a certain method step or not. Thus, the laboratory analyzer may detect whether the pipetting process is or will be carried out by the operator according to the workflow or not.

In one embodiment, the camera may be adapted to acquire the data from the vision analysis at predetermined method steps according to the workflow. In other words, the camera may not acquire the data permanently but only at predefined method steps. For example, the camera can acquire data at each method step the operator aspirates reagent into the pipette and/or dispenses reagent therefrom according to the workflow. Thus, the amount of data acquired may be reduced to important or essential data.

In addition or alternatively, the camera may be adapted to acquire the data from the vision analysis within predetermined time periods. In other words, the camera may not acquire the data permanently but only at predefined points of time. For example, the camera can acquire data about every 5 seconds or any other time period which may be a time period necessary for carrying out a method step. Thus, the amount of data acquired may be reduced to important or essential data.

The data may include positions of the pipette and the target data may include target positions of the pipette and/or positions of the reagent vessels. Thus, a detection whether the pipette and/or the reagent vessels are at the correct positions or not according to the workflow can be provided.

The target positions may be correlated to the plurality of method steps of the workflow. Thus, a detection whether the pipette and/or the reagent vessels are at the correct positions or not according to one or more method steps of the workflow can be provided.

The computing device may be adapted to signalize a deviation of the data from the target data. For example, the computing device can be adapted to acoustically and/or visually signalize the deviation of the data from the target data. Thus, the operator may be informed of any incorrect operation according to the workflow.

The pipette may be adapted to acquire pipetting data of the pipetting process and the computing device may be adapted to compare the pipetting data to target pipetting data correlated to the plurality of method steps of the workflow. Thus, a detection whether the pipetting process is carried out by the operator correctly or not according to the workflow can be provided.

The computing device may be adapted to signalize a deviation of the pipetting data from the target pipetting data. For example, the computing device can be adapted to acoustically and/or visually signalize the deviation of the pipetting data from the target pipetting data. Thus, the operator may be informed of any incorrect pipetting process according to the workflow.

Pipetting data can be data acquired by the pipette which can include at least a volume of reagent aspirated into and/or dispensed from the pipette.

The target data can be correlated to each method step of the plurality of method steps of the workflow. In other words, target data can be associated with each method step such that the target data of the respective method steps can be independent on one another. The camera may be adapted to acquire the data of each method step of the pipetting process carried out by the operator. Thus, every single method step can be visually observed by the camera. The computing device may be adapted to display the plurality of method steps in a subsequent order. In other words, the method steps can be present in a predefined order according to the workflow. The computing device may be adapted to display a following method step of the subsequent order if the data of a previous method step which is previous to the following method step corresponds to the correlated target data. In other words, the display can display a next method step according to the workflow only if the previous method step has been carried out correctly. Thus, in case an incorrect method step is or will be carried out by the operator, the workflow can be terminated or interrupted in order to prevent a wrong progress of the workflow. Accordingly, the operator can be safely guided through the workflow.

The data acquired by the camera may comprise images of at least the plurality of compartments. Thus, the computing device may compare these images with the target data which may be images expected to be present at a predetermined method step. In other words, the computing may detect a match or mismatch of images correlated to the method steps of workflow.

The target data may be stored on the computing device and/or a storage medium external to the computing device such as an USB stick or the like. Thus, different target data correlated to different workflows may be stored on the computing device or input therein.

A method for operating a laboratory analyzer for manually handling a plurality of reagents is disclosed. The method can comprise displaying a workflow of a pipetting process comprising a plurality of method steps to an operator, acquiring data from a vision analysis of at least a plurality of reagent vessels during manually carrying out a pipetting process by an operator according to the workflow, and comparing the data to target data correlated to the plurality of method steps of the workflow. Thus, the method can allow detection of whether the pipetting process is or will be carried out by the operator according to the workflow or not.

The data from the vision analysis may be acquired at predetermined method steps according to the workflow. Thus, the amount of data acquired may be reduced to important or essential data.

In addition or alternatively, the data from the vision analysis can be acquired within predetermined time periods. Thus, the amount of data acquired may be reduced to important or essential data.

The data may include positions of a pipette of the laboratory analyzer and the target data can include target positions of the pipette and/or positions of the reagent vessels. Thus, a detection whether the pipette and/or the reagent vessels are at the correct positions or not according to the workflow can be provided.

The target positions can be correlated to the plurality of method steps of the workflow. Thus, detection of whether the pipette and/or the reagent vessels are at the correct positions or not according to one or more method steps of the workflow can be provided.

A deviation of the data from the target data may be signalized. In one embodiment, the deviation of the data from the target data may be acoustically and/or visually signalized. Thus, an operator may be informed of any incorrect operation according to the workflow.

Further, pipetting data of the pipetting process may be acquired and the pipetting data can be compared to target pipetting data correlated to the plurality of method steps of the workflow. Thus, detection of whether the pipetting process is carried out by the operator correctly or not according to the workflow can be provided.

A deviation of the pipetting data from the target pipetting data may be signalized. In one embodiment, the deviation of the pipetting data from the target pipetting data may be acoustically and/or visually signalized. Thus, an operator may be informed of any incorrect pipetting process according to the workflow.

The pipetting data may include at least a volume of reagent aspirated into and/or dispensed from the pipette.

The target data may be correlated to each method step of the plurality of method steps of the workflow. The data of each method step of the pipetting process carried out by the operator may be acquired. The plurality of method steps may be displayed in a subsequent order, and a following method step of the subsequent order may be displayed if the data of a previous method step which is previous to the following method step corresponds to the correlated target data. Thus, in case an incorrect method step is or will be carried out by the operator, the workflow can be terminated or interrupted in order to prevent a wrong progress of the workflow. Accordingly, the operator can be safely guided through the workflow.

The acquired data may comprise images of at least the plurality of reagent vessels. Thus, these images may be compared with the target data which may be images expected to be present at a predetermined method step. In other words, a match or mismatch of images correlated to the method steps of workflow may be detected.

The target data may be stored on a computing device of the laboratory analyzer and/or a storage medium. Thus, different target data correlated to different workflows may be stored on the computing device or input therein.

A computer program including computer-executable instructions for performing the method in one or more of the embodiments enclosed herein when the program is executed on a computer or computer network is presented. Specifically, the computer program may be stored on a computer-readable data carrier. Thus, specifically, one, more than one or even all of the method steps as indicated above may be performed by using a computer or a computer network, by using a computer program.

A computer program product having program code, in order to perform the method in one or more of the embodiments enclosed herein when the program is executed on a computer or computer network is presented. Specifically, the program code may be stored on a computer-readable data carrier.

Further, a data carrier having a data structure stored thereon, which, after loading into a computer or computer network, such as into a working memory or main memory of the computer or computer network, may execute the method according to one or more of the embodiments disclosed herein is presented.

A computer program product with program code stored on a machine-readable carrier, in order to perform the method according to one or more of the embodiments disclosed herein, when the program is executed on a computer or computer network is presented. As used herein, a computer program product can refer to the program as a tradable product. The product may generally exist in an arbitrary format, such as in a paper format, or on a computer-readable data carrier. Specifically, the computer program product may be distributed over a data network.

Finally, a modulated data signal which contains instructions readable by a computer system or computer network, for performing the method according to one or more of the embodiments disclosed herein is presented.

Referring to the computer-implemented embodiments, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, the present disclosure further discloses:

computer or computer network comprising at least one processor, wherein the processor can be adapted to perform the method according to one of the embodiments described in this description,

a computer loadable data structure that can be adapted to perform the method according to one of the embodiments described in this description while the data structure can be executed on a computer,

a computer program, wherein the computer program can be adapted to perform the method according to one of the embodiments described in this description while the program can be executed on a computer,

a computer program comprising a program for performing the method according to one of the embodiments described in this description while the computer program can be executed on a computer or on a computer network,

a computer program comprising a program according to the preceding embodiment, wherein the program can be stored on a storage medium readable to a computer,

a storage medium, wherein a data structure can be stored on the storage medium and wherein the data structure can be adapted to perform the method according to one of the embodiments described in this description after having been loaded into a main and/or working storage of a computer or of a computer network, and

a computer program product having a program code, wherein the program code can be stored or are stored on a storage medium, for performing the method according to one of the embodiments described in this description, if the program code means are executed on a computer or on a computer network.

A laboratory analyzer for manually handling a plurality of reagents is presented. The laboratory analyzer can comprise a computing device comprising a display for displaying a workflow of a pipetting process comprising a plurality of method steps to an operator, a pipette for pipetting reagents connected to the computing device, a plurality of compartments for receiving a plurality of reagents vessels including reagents to be pipetted by means of the pipette, and a camera connected to the computing device. The camera can be adapted to acquire data from a vision analysis of at least the plurality of compartments during manually carrying out a pipetting process by the operator according to the workflow. The computing device can be adapted to compare the data to target data correlated to the plurality of method steps of the workflow.

The camera can be adapted to acquire the data from the vision analysis at predetermined method steps according to the workflow. The camera can be adapted to acquire the data from the vision analysis within predetermined time periods.

The data can include positions of the pipette. The target data can include target positions of the pipette and/or positions of the reagent vessels. The target positions can be correlated to the plurality of method steps of the workflow.

The computing device can be adapted to signalize a deviation of the data from the target data. The computing device can be adapted to acoustically and/or visually signalize the deviation of the data from the target data.

The pipette can be adapted to acquire pipetting data of the pipetting process. The computing device can be adapted to compare the pipetting data to target pipetting data correlated to the plurality of method steps of the workflow. The computing device can be adapted to signalize a deviation of the pipetting data from the target pipetting data. The computing device can be adapted to acoustically and/or visually signalize the deviation of the pipetting data from the target pipetting data. The pipetting data can include at least a volume of reagent aspirated into and/or dispensed from the pipette.

The target data can be correlated to each method step of the plurality of method steps of the workflow. The camera can be adapted to acquire the data of each method step of the pipetting process carried out by the operator. The computing device can be adapted to display the plurality of method steps in a subsequent order and the computing device can be adapted to display a following method step of the subsequent order if the data of a previous method step which is previous to the following method step corresponds to the correlated target data.

The data acquired by the camera can comprise images of at least the plurality of compartments.

The target data can be stored on the computing device and/or a storage medium.

A method for operating a laboratory analyzer for manually handling a plurality of reagents is disclosed. The method can comprise displaying a workflow of a pipetting process comprising a plurality of method steps to an operator, acquiring data from a vision analysis of at least a plurality of reagent vessels during manually carrying out a pipetting process by an operator according to the workflow, and comparing the data to target data correlated to the plurality of method steps of the workflow.

The data from the vision analysis can be acquired at predetermined method steps according to the workflow. The data from the vision analysis can be acquired within predetermined time periods. The data can include positions of a pipette of the laboratory analyzer. The target data can include target positions of the pipette and/or positions of the reagent vessels. The target positions can be correlated to the plurality of method steps of the workflow.

The method can further comprise signalizing a deviation of the data from the target data. The deviation of the data from the target data can be acoustically and/or visually signalized.

The pipetting process can be acquired. The pipetting data can be compared to target pipetting data correlated to the plurality of method steps of the workflow.

The method can further comprises signalizing a deviation of the pipetting data from the target pipetting data. The deviation of the pipetting data from the target pipetting data can be acoustically and/or visually signalized.

The pipetting data can include at least a volume of reagent aspirated into and/or dispensed from the pipette.

The target data can be correlated to each method step of the plurality of method steps of the workflow. The data of each method step of the pipetting process carried out by the operator can be acquired. The plurality of method steps can be displayed in a subsequent order and a following method step of the subsequent order can be displayed if the data of a previous method step which is previous to the following method step corresponds to the correlated target data.

The acquired data can comprise images of at least the plurality of reagent vessels.

The target data can be stored on a computing device of the laboratory analyzer and/or a storage medium.

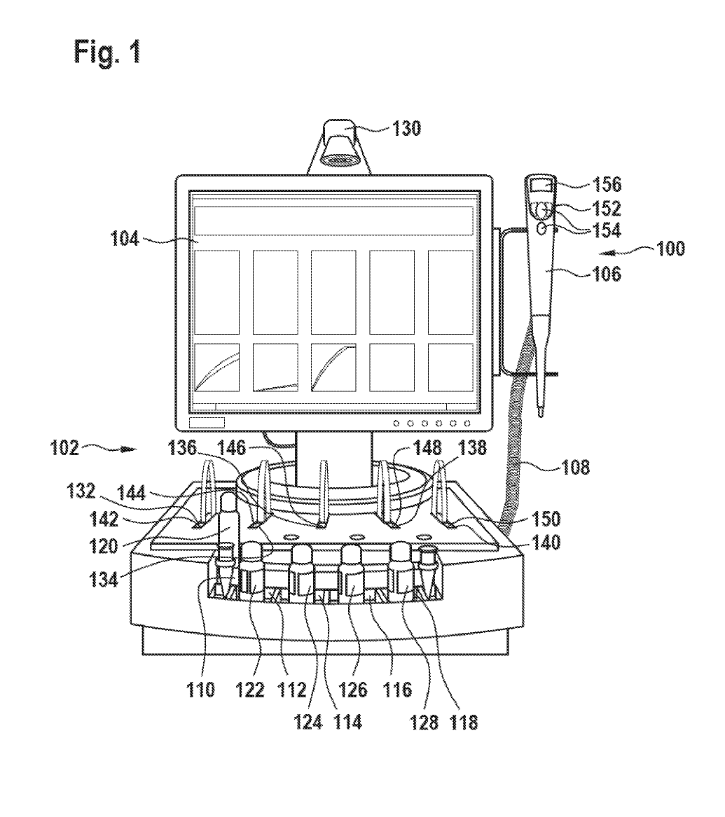

FIG. 1 shows a perspective view of a laboratory analyzer 100 for manually handling a plurality of reagents. The laboratory analyzer 100 may be a benchtop laboratory instrument like, for example, a platelet function analyzer. The laboratory analyzer 100 can comprise a computing device 102. The computing device 102 can comprise a display 104 for displaying a workflow of a pipetting process comprising a plurality of method steps to an operator. The computing device 104 may be a commercially available PC and the display 104 may be the monitor of the PC.

The laboratory analyzer 100 can further comprise a pipette 106 for pipetting reagents. The pipette 106 can be connected to the computing device 102. In one embodiment, the pipette 106 can be an electronic pipette and can be electronically connected to the computing device 102. In the embodiment shown in FIG. 1, the pipette 106 can be connected to the computing device 102 by a cable 108. For example, both of the pipette 106 and the computing device 102 may comprise an USB interface and the cable 108 may be an USB cable which can be connected to the pipette 106 and the computing device 102. It can be stated that the pipette 106 may be connected to the computing device by any electronic connection known to the person skilled in the art. For example, alternatively, the pipette 106 may be connected to the computing device 102 by a wireless connection such as radio communication, Bluetooth or the like.

The laboratory analyzer 100 can further comprise a plurality of compartments 110, 112, 114, 116, 118 for receiving a plurality of reagents vessels 120, 122, 124, 126, 128 for storing reagents to be pipetted by the pipette 106. In the embodiment shown in FIG. 1, the laboratory analyzer 100 can comprise five compartments 110, 112, 114, 116, 118 for receiving five reagents vessels 120, 122, 124, 126, 128. Needless to say, the number of compartments may not be limited to five but may be more or less. In one embodiment, the laboratory analyzer 100 can comprise at least two compartments. The compartments 110, 112, 114, 116, 118 can be arranged in a row from the left to the right with respect to the illustration of FIG. 1. As such, the compartments 110, 112, 114, 116, 118 may be indicated as a first compartment 110, a second compartment 112, a third compartment 114, a fourth compartment 116 and a fifth compartment 118 as seen from the left to the right. The expressions first, second, third, fourth and fifth are not intended to indicate a certain order of importance but are merely intended to facilitate a differentiation of the respective compartments 110, 112, 114, 116, 118. Analogously, the reagents vessels 120, 122, 124, 126, 128 may be indicated as a first reagent vessel 120, a second reagent vessel 122, a third reagent vessel 124, a fourth reagent vessel 126 and a fifth reagent vessel 128 as seen from the left to the right. The expressions first, second, third, fourth and fifth are not intended to indicate a certain order of importance but are merely intended to facilitate a differentiation of the respective reagents vessels 120, 122, 124, 126, 128.

The laboratory analyzer 100 can further comprise a camera 130. The camera 130 can be connected to the computing device 102. The camera 130 may be arranged at a top of the display 104. The camera 130 can be adapted to acquire data from a vision analysis of at least the plurality of compartments 110, 112, 114, 116, 118 during manually carrying out a pipetting process by the operator according to the workflow. The computing device 102 can be adapted to compare the data to target data correlated to the plurality of method steps of the workflow. The target data can be stored on the computing device 102 and/or a storage medium such as an USB stick, a disc and the like.

The laboratory analyzer 100 can further comprise a plurality of cuvette compartments 132, 134, 136, 138, 140 for receiving a plurality of cuvettes 142, 144, 146, 148, 150. In the embodiment shown in FIG. 1, the laboratory analyzer 100 can comprise five cuvette compartments 132, 134, 136, 138, 140 for receiving five cuvettes 142, 144, 146, 148, 150. Needless to say, the number of cuvette compartments may not be limited to five but may be more or less. The cuvette compartments 132, 134, 136, 138, 140 can be arranged in a row from the left to the right with respect to the illustration of FIG. 1. As such, the cuvette compartments 132, 134, 136, 138, 140 may be indicated as a first cuvette compartment 132, a second cuvette compartment 134, a third cuvette compartment 136, a fourth cuvette compartment 138 and a fifth cuvette compartment 140 as seen from the left to the right. The expressions first, second, third, fourth and fifth are not intended to indicate a certain order of importance but are merely intended to facilitate a differentiation of the respective cuvette compartments 132, 134, 136, 138, 140. Analogously, the cuvettes 142, 144, 146, 148, 150 may be indicated as a first cuvette 142, a second cuvette 144, a third cuvette 146, a fourth cuvette 148 and a fifth cuvette 150 as seen from the left to the right. The expressions first, second, third, fourth and fifth are not intended to indicate a certain order of importance but are merely intended to facilitate a differentiation of the respective cuvettes 142, 144, 146, 148, 150. The cuvettes 142, 144, 146, 148, 150 can be adapted to receive a mixture of reagents pipetted from at least some of the reagent vessels 120, 122, 124, 126, 128 therein. The mixture of reagents in the cuvettes 142, 144, 146, 148, 150 can be analyzed by the laboratory analyzer 100.

The camera 130 can be adapted to acquire the data from the vision analysis at predetermined method steps according to the workflow. In one embodiment, the camera 130 can be adapted to acquire the data from the vision analysis within predetermined time periods such as about every 5 seconds. The data acquired by the camera 130 can comprise images of at least the plurality of compartments 110, 112, 114, 116, 118. In other words, the camera 130 can be adapted to take images of at least the plurality of compartments 110, 112, 114, 116, 118. The data can include positions of the pipette 106. In other words, the data can be correlated to positions of the pipette 106 at the laboratory analyzer 100. For example, the data can include information where the pipette 106 is positioned at the reagent vessels 120, 122, 124, 126, 128 or the compartments 110, 112, 114, 116, 118 and/or the cuvette compartments 142, 144, 146, 148, 150. The target data can include target positions of the pipette 106 and/or positions of the reagent vessels 120, 122, 124, 126, 128. The target positions can be correlated to the plurality of method steps of the workflow. In other words, the target data can include positions where the pipette 106 and/or the reagent vessels 120, 122, 124, 126, 128 can be expected to be located at a predetermined method step as will be explained in further detail below. The computing device 102 can be adapted to signalize a deviation of the data from the target data. In one embodiment, the computing device 102 can be adapted to acoustically and/or visually signalize the deviation of the data from the target data. For example, if the computing device 102 determines a deviation of the data from the target data, an alert can sound by a siren and/or can be displayed on the display 104.

The pipette 106 can be adapted to acquire pipetting data of the pipetting process. The computing device 102 can be adapted to compare the pipetting data to target pipetting data correlated to the plurality of method steps of the workflow. The computing device 102 can be adapted to signalize a deviation of the pipetting data from the target pipetting data. In one embodiment, the computing device 102 can be adapted to acoustically and/or visually signalize the deviation of the pipetting data from the target pipetting data. For example, if the computing device 102 determines a deviation of the pipetting data from the target pipetting data, an alert can sound by a siren and/or can be displayed on the display 104. The pipetting data can include at least a volume of reagent aspirated into and/or dispensed from the pipette 106. For this reason, the pipette 106 may comprise an electronics card 152 comprising knobs 154 and a pipette display 156. The electronics card 152 can be arranged within the pipette 106 and can be adapted to detect the volume of reagent aspirated into and/or dispensed from the pipette 106.

Optionally, the target data can be correlated to each single method step of the plurality of method steps of the workflow. The camera 130 can be adapted to acquire the data of each single method step of the pipetting process carried out by the operator. The computing device 102 can be adapted to display the plurality of method steps in a subsequent order. The computing device 102 can be adapted to display a following method step of the subsequent order if the data of a previous method step which is previous to the following method step corresponds to the correlated target data.

Hereinafter, a method for operating the laboratory analyzer 100 will be described. An operator can activate the computing device 102. Further, the operator can activate the pipette 106. Then, the operator can select a predetermined pipetting process to be carried out. The computing device 102 can display a workflow of the selected pipetting process comprising a plurality of method steps to the operator on the display 104. The method steps can include information of the reagent vessels 120, 122, 124, 126, 128. In one embodiment, the method steps can include information which one of the reagent vessels 120, 122, 124, 126, 128 has to be disposed in which one of the compartments 110, 112, 114, 116, 118. For example, information can be displayed on the display 104 indicating that the first reagent vessel 120 has to be disposed in the first compartment 110, that the second reagent vessel 122 has to be disposed in the second compartment 112 etc. The reagent vessels 120, 122, 124, 126, 128 can bear information of the reagents stored therein. For example, the reagent vessels 120, 122, 124, 126, 128 can be marked such as by different colors so as to facilitate identification of the respective reagents stored therein.

Then the computing device 102 can activate the camera 130 in order to acquire data from a vision analysis of at least a plurality of reagent vessels 120, 122, 124, 126, 128 during manually carrying out a pipetting process by the operator according to the workflow. The acquired data can comprise images of at least the plurality of reagent vessels 120, 122, 124, 126, 128. The data from the vision analysis can be acquired at predetermined method steps according to the workflow. As such, a first method step of the pipetting process according to the workflow may be seen in the arrangement of the reagent vessels 120, 122, 124, 126, 128 at the compartments 110, 112, 114, 116, 118. Alternatively or in addition, the data from the vision analysis can be acquired within predetermined time periods such as about every 5 seconds.

The display 104 can display further method steps of the pipetting process according to the workflow. For example, the display 104 can display the instruction to use the pipette 106 in order to aspirate a predetermined amount of the reagent stored within the first reagent vessel 120 and to dispense the predetermined amount into the fifth reagent vessel 128. As such a second method step of the pipetting process according to the workflow may be seen in a first aspirating process and a third method step of the pipetting process according to the workflow may be seen in a first dispensing process. During these method steps of the manual pipetting process, the camera 130 can also acquire further data from the vision analysis of at least a plurality of reagent vessels 120, 122, 124, 126, 128. The data can include positions of the pipette 106. In other words, the camera 130 can take images of the reagents vessels 120, 122, 124, 126, 128 and the pipette 106 located at the reagents vessels 120, 122, 124, 126, 128 or in the vicinity thereof.

The computing device 102 can compare the data to target data correlated to the plurality of method steps of the workflow. The target data can be stored on the computing device 102. Alternatively or in addition, the target data can be stored on a storage medium such as an USB stick, a disc, and the like. The target data can include target positions of the pipette 106 and/or positions of the reagent vessels 120, 122, 124, 126, 128. The target positions can be correlated to the plurality of method steps of the workflow. In other words, the target data can include information where the pipette 106 and/or positions of the reagent vessels 120, 122, 124, 126, 128 are expected to be located at a predetermined method step according to the workflow. For example, the target data can include information that the first reagent vessel 120 is expected to be disposed in the first compartment 110, that the second reagent vessel 122 is expected to be in the second compartment 112 etc. in the above mentioned first method step. Further, regarding this given example, the target data can include information that the pipette 106 and the pipette tip thereof, respectively, is expected to be located at the first reagent vessel 120 in the above second method step and that the pipette 106 is expected to be located at the fifth reagent vessel 128 in the above third method step. The computing device 102 can compare the images taken by the camera 130 with this information of the target data.

In case the computing device 102 detects a mismatch of the data and the target data, the computing device 102 can signalize this deviation of the data from the target data to the operator. For example, if the operator has disposed the reagent vessels 120, 122, 124, 126, 128 at incorrect positions or compartments 110, 112, 114, 116, 118 or has aspirated a wrong reagent or dispensed the reagent into the wrong one of reagent vessels 120, 122, 124, 126, 128 or the pipette 106 is located at a wrong one of reagent vessels 120, 122, 124, 126, 128 according to the associated or correlated method step, the computing devices 102 can detect a deviation of the data from the target data. The computing device 102 may acoustically and/or visually signalize the deviation of the data from the target data. For example, the computing device 102 may activate an alert that can be heard by the operator and/or display an alert on the display 104 that can be seen by the operator. Needless to say, the workflow may comprise further method steps not described in detail. For example, the workflow may comprise aspirating and dispensing further reagents into the fifth reagent vessel 128 or another one of the reagent vessels 120, 122, 124, 126, 128 or into a predetermined one of the cuvettes 142, 144, 146, 148, 150 depending on the respective analyze to be carried out.

Further, the pipette 106 may acquire pipetting data of the pipetting process. The pipetting data can include at least a volume of reagent aspirated into and/or dispensed from the pipette 106. Regarding the above example, the pipette 106 can detect an amount of about 20 ml aspirated from the first reagent vessel 120 and an amount of about 20 ml dispensed into the fifth reagent vessel 128. The computing device 102 can compare the pipetting data to target pipetting data correlated to the plurality of method steps of the workflow. In other words, the computing device 102 can compare whether the amount aspirated into the pipette 106 and dispensed from the pipette 106 corresponds to a target amount to be aspirated and to a target amount to be dispensed in the above second and third method steps. In case the computing device 102 detects a deviation of the pipetting data from the target pipetting data, this deviation can be signalized to the operator. The deviation of the pipetting data from the target pipetting data may be acoustically and/or visually signalized to the operator. For example, if the computing device 102 detects that the amount aspirated into the pipette 106 and dispensed from the pipette 106 does not correspond to the target amount to be aspirated and to the target amount to be dispensed in the above second and third method steps, the computing device 102 may activate an alert that can be heard by the operator and/or display an alert on the display 104 that can be seen by the operator.

Optionally, the target data can be correlated to each method step of the plurality of method steps of the workflow and the data of each method step of the pipetting process carried out by the operator can be acquired. The plurality of method steps can be displayed on the display 104 in a predetermined subsequent order and a following method step of the subsequent order can be displayed only if the data of a previous method step which is previous to the following method step corresponds to the correlated target data of the previous method step. In other words, the computing device 102 can only activate the display 104 to display the next method step to be carried out if the previous method step carried out by the operator fully corresponds to an expected method step to be carried out according to the workflow.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A laboratory analyzer for manually handling a plurality of reagents, the laboratory analyzer comprising:
a computing device comprising a display for displaying a workflow of a pipetting process comprising a plurality of method steps to an operator;
a pipette for pipetting reagents connected to the computing device;
a plurality of compartments for receiving a plurality of reagents vessels including reagents to be pipetted by the pipette;
a camera connected to the computing device, wherein the camera is adapted to acquire data from a vision analysis of at least the plurality of compartments during manually carrying out a pipetting process by the operator according to the workflow, wherein the computing device is adapted to compare the data to target data correlated to the plurality of method steps of the workflow.

2. The laboratory analyzer according to claim 1, wherein the camera is adapted to acquire the data from the vision analysis at predetermined method steps according to the workflow and/or within predetermined time periods.

3. The laboratory analyzer according to claim 2, wherein the data include positions of the pipette, wherein the target data include target positions of the pipette and/or positions of the reagent vessels, and wherein the target positions are correlated to the plurality of method steps of the workflow.

4. The laboratory analyzer according to claim 1, wherein the computing device is adapted to signalize a deviation of the data from the target data.

5. The laboratory analyzer according to claim 4, wherein the deviation of the data from the target data is signalize acoustically and/or visually.

6. The laboratory analyzer according to claim 1, wherein the pipette is adapted to acquire pipetting data of the pipetting process, wherein the computing device is adapted to compare the pipetting data to target pipetting data correlated to the plurality of method steps of the workflow.

7. The laboratory analyzer according to claim 6, wherein the pipetting data includes at least a volume of reagent aspirated into and/or dispensed from the pipette.

8. The laboratory analyzer according to claim 1, wherein the computing device is adapted to signalize a deviation of the pipetting data from the target pipetting data. particularly, to acoustically and/or visually signalize the deviation of the pipetting data from the target pipetting data.

9. The laboratory analyzer according to claim 8, wherein the deviation of the pipetting data from the target pipetting data is signalize acoustically and/or visually.

10. The laboratory analyzer according to claim 1, wherein the target data are correlated to each method step of the plurality of method steps of the workflow, wherein the camera is adapted to acquire the data of each method step of the pipetting process carried out by the operator, wherein the computing device is adapted to display the plurality of method steps in a subsequent order, and the computing device is adapted to display a following method step of the subsequent order if the data of a previous method step which is previous to the following method step corresponds to the correlated target data.

11. The laboratory analyzer according to claim 1, wherein the data acquired by the camera comprise images of at least the plurality of compartments.

12. A method for operating a laboratory analyzer for manually handling a plurality of reagents, the method comprising:
displaying a workflow of a pipetting process comprising a plurality of method steps to an operator;
acquiring data from a vision analysis of at least a plurality of reagent vessels during manually carrying out a pipetting process by an operator according to the workflow, comparing the data to target data correlated to the plurality of method steps of the workflow.

13. The method according to claim 12, wherein the data from the vision analysis are acquired at predetermined method steps according to the workflow and/or within predetermined time periods.

14. The method according to claim 12, wherein the data include positions of a pipette of the laboratory analyzer, wherein the target data include target positions of the pipette and/or positions of the reagent vessels, wherein the target positions are correlated to the plurality of method steps of the workflow.

15. The method according to claim 12, further comprising,
signalizing a deviation of the data from the target data.

16. The method according to claim 15, wherein the signalization is acoustically and/or visually.

17. The method according to claim 12, wherein pipetting data of the pipetting process are acquired, wherein the pipetting data are compared to target pipetting data correlated to the plurality of method steps of the workflow.

18. The method according to claim 17, wherein the pipetting data includes at least a volume of reagent aspirated into and/or dispensed from the pipette

19. The method according to claim 12, further comprising signalizing a deviation of the pipetting data from the target pipetting data.

20. The method according to claim 12, wherein the target data are correlated to each method step of the plurality of method steps of the workflow, wherein the data of each method step of the pipetting process carried out by the operator are acquired, wherein the plurality of method steps are displayed in a subsequent order, and a following method step of the subsequent order is displayed if the data of a previous method step which is previous to the following method step corresponds to the correlated target data.
